(19) United States
(12) Patent Application Publication
(10) Pub. No.: US 2007/0034231 A1
(43) Pub. Date: Feb. 15, 2007

(54) SUBSTRATE TREATING APPARATUS AND METHOD

(76) Inventor: Hiroaki Takahashi, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/462,170

(22) Filed: Aug. 3, 2006

(30) Foreign Application Priority Data
Aug. 11, 2005 (JP) 2005-233324

(51) Int. Cl. C23G 1/00; C23G 1/02; B08B 7/00; B08B 3/04

(52) U.S. Cl. 134/3; 134/104.2; 134/42; 134/2

(57) ABSTRACT

A substrate treating method for treating substrates with a treating solution including sulfuric acid and a hydrogen peroxide solution. The method includes a first preparing step for preparing dilute sulfuric acid of a predetermined concentration by mixing deionized water and sulfuric acid, a second preparing step for preparing the treating solution by mixing the dilute sulfuric acid prepared in the first preparing step and the hydrogen peroxide solution, and a treating step for treating the substrates, in a treating unit that holds the substrates, with the treating solution prepared in the second preparing step.

### BACKGROUND OF THE INVENTION

(1) Field of the Invention

This invention relates to a substrate treating method and apparatus for treating substrates such as semiconductor wafers or glass substrates for liquid crystal displays (hereinafter called simply substrates) with a treating solution including sulfuric acid and a hydrogen peroxide solution.

(2) Description of the Related Art

Conventionally, this type of apparatus includes a treating tank for receiving substrates, a sulfuric acid supply line for supplying sulfuric acid (H₂SO₄) to the treating tank, and a hydrogen peroxide solution supply line for supplying a hydrogen peroxide solution (H₂O₂) to the treating tank (e.g. Japanese Unexamined Patent Publication H5-166780 (1993)). This apparatus, before treating the substrates, supplies the sulfuric acid and hydrogen peroxide solution in a predetermined mixing ratio (e.g. 7:3) to the treating tank, and stores the treating solution in the treating tank. This treating solution serves mainly to remove organic substances adhering to the substrates, and is called SPM solution (Sulfuric Acid/Hydrogen Peroxide/Water Mixture). The apparatus carries out cleaning treatment for removing organic substances adhering to the substrates loaded into in the treating tank.

The conventional apparatus noted above has the following drawbacks.

The SPM solution has heretofore been considered to show the greater cleaning capability, the higher its temperature is. It is therefore conventional practice to prepare a treating solution by mixing the hydrogen peroxide solution with sulfuric acid heated to about 100° C. The temperature of the treating solution rises sharply due to a reaction occurring when sulfuric acid and the hydrogen peroxide solution are mixed. It is difficult to attain a target temperature for treatment (e.g. 160° C.) despite temperature control of the treating solution. This results in difficulties in handling the treating solution. Moreover, the treating solution can be heated to temperatures higher than is expected, and thus a possibility of adversely influencing components of the substrate treating apparatus.

### SUMMARY OF THE INVENTION

This invention has been made having regard to the state of the art noted above, and its object is to provide a substrate treating method and apparatus which suppress a temperature increase of a treating solution caused by a reaction, thereby to facilitate handling of the treating solution, and eliminate the possibility of adversely influencing components.

The above object is fulfilled, according to this invention, by a substrate treating method for treating substrates with a treating solution including sulfuric acid and a hydrogen peroxide solution, comprising a first preparing step for preparing dilute sulfuric acid of a predetermined concentration by mixing deionized water and sulfuric acid; a second preparing step for preparing the treating solution by mixing the dilute sulfuric acid prepared in the first preparing step and the hydrogen peroxide solution; and a treating step for treating the substrates, in a treating unit that receives the substrates, with the treating solution prepared in the second preparing step.

According to this invention, dilute sulfuric acid is prepared beforehand in the first preparing step, the treating solution is prepared in the second preparing step by mixing the dilute sulfuric acid and the hydrogen peroxide solution, and the substrates are treated in the treating step by using the treating solution prepared. Since the treating solution is prepared by mixing the hydrogen peroxide solution and the dilute sulfuric acid prepared beforehand, a rapid reaction is inhibited to avoid a temperature increase of the treating solution due to the reaction. This facilitates a temperature control to attain a treating temperature, and facilitates handling of the treating solution. Since the treating solution is never heated to temperatures higher than is expected, there is no possibility of adversely influencing components.

In this invention, the first preparing step may be executed to maintain a fixed sulfuric acid concentration in the dilute sulfuric acid, after the dilute sulfuric acid of the predetermined concentration is prepared, by adding the deionized water or the sulfuric acid according to concentration variations of the dilute sulfuric acid.

By maintaining the concentration of the dilute sulfuric acid at a fixed level, the treating solution prepared is given a constant treating capability, thereby stabilizing the treatment over a long period of time.

The second preparing step may be executed to supply the dilute sulfuric acid and the hydrogen peroxide solution directly to the treating unit.

Since the treating solution is prepared in the treating unit, the substrates can be treated while maintaining the high treating capability.

In this invention, the concentration of the dilute sulfuric acid may be 70 to 90% by weight.

With concentrations less than 70% by weight, treating speed is too slow and treatment takes a long time although low temperatures are attained due to temperature increase. On the other hand, concentrations exceeding 90% by weight result in temperatures attained due to temperature increase nearly as high as in the prior art, and in slow treating speeds requiring a long treating time. Thus, a preferred concentration is in the range of 70 to 90% by weight, which attains a lower temperature than in the prior art, and secures a higher treating speed than in the prior art.

In another aspect of the invention, a substrate treating apparatus is provided for treating substrates with a treating solution including sulfuric acid and a hydrogen peroxide solution. The apparatus comprises a mixing unit for mixing deionized water and sulfuric acid to prepare dilute sulfuric acid of a predetermined concentration; a sulfuric acid supply device for supplying the sulfuric acid to the mixing unit; a deionized water supply device for supplying the deionized water to the mixing unit; a treating unit for receiving the substrates and treating the substrates with the treating solution; and a treating solution supply device for supplying the treating unit with the hydrogen peroxide solution and the dilute sulfuric acid from the mixing unit as the treating solution.

According to this invention, dilute sulfuric acid is prepared beforehand in the mixing unit by mixing the sulfuric acid from the sulfuric acid supply device and the deionized water from the deionized water supply device. Then, the treating solution supply device supplies the treating unit with the hydrogen peroxide solution and the dilute sulfuric acid from the mixing unit to form the treating solution, and the substrates are immersed in the treating solution for treatment. Since the treating solution is prepared by mixing the hydrogen peroxide solution and the dilute sulfuric acid prepared beforehand in the mixing unit, a rapid reaction is inhibited to avoid a temperature increase of the treating solution due to the reaction. This facilitates a temperature control to attain a treating temperature, and facilitates handling of the treating solution. Since the treating solution is never heated to temperatures higher than is expected, there is no possibility of adversely influencing components such as the treating unit.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a block diagram showing an outline of a substrate treating apparatus in Embodiment 1;

FIG. 2 is a flow chart showing a preparing process;

FIG. 3 is a flow chart showing a treating process;

FIG. 4A is a schematic view of a sample;

FIG. 4B is a graph comparing stripping capabilities of this invention and the prior art; and

FIG. 5 is a block diagram showing an outline of a substrate treating apparatus in Embodiment 2.

### DESCRIPTION OF THE PREFERRED EMBODIMENTS

Preferred embodiments of this invention will be described in detail hereinafter with reference to the drawings.

### Embodiment 1

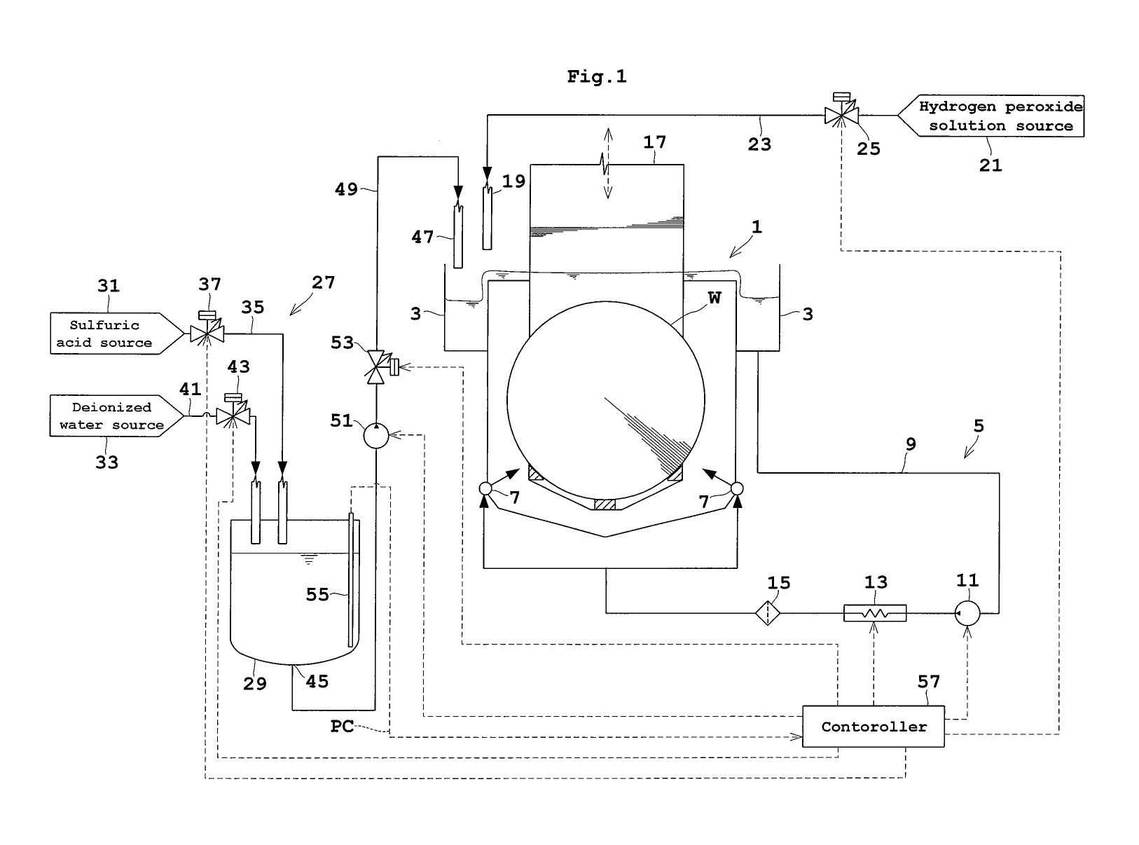

FIG. 1 is a block diagram showing an outline of a substrate treating apparatus in Embodiment 1.

The substrate treating apparatus includes a treating tank 1 (treating unit) for storing a treating solution including sulfuric acid and a hydrogen peroxide solution, and for receiving substrates or wafers W for immersion in the treating solution. A collecting tank 3 is disposed around the treating tank 1 for collecting the treating solution overflowing the treating tank 1. The treating solution collected in the collecting tank 3 is returned to the treating tank 1 through a circulating system 5. The circulating system 5 includes piping 9 extending from the collecting tank 3 to filling pipes 7 arranged at the bottom of the treating tank 1. The piping 9 has, arranged thereon, a feeding pump 11, an in-line heater 13 and a filter 15. The filling pipes 7 supply the treating solution and deionized water obliquely upward from lower parts of the treating tank 1. The in-line heater 13 serves to heat, in the circulating system 5, the treating solution returned to the treating tank 1. The heater 13 heats the solution to about 160° C., for example. The filter 15 is provided for removing particles from the treating solution returned to the treating tank 1.

A plurality of wafers W are supported in vertical posture, and as arranged equidistantly, on a vertically movable holding arm 17. The holding arm 17 is vertically movable between a “standby position” above the treating tank 1 and a “treating position” inside the treating tank 1.

The collecting tank 3 includes a nozzle 19 for supplying the hydrogen peroxide solution. The nozzle 19 has piping 23 connected to a hydrogen peroxide solution source 21, and a control valve 25 mounted on the piping 23. The control valve 25 controls supply at a predetermined flow rate and cutoff of the hydrogen peroxide solution.

The substrate treating apparatus has a preliminary mixing unit 27 (mixing unit). The preliminary mixing unit 27 mixes beforehand, in a mixing tank 29, sulfuric acid from a sulfuric acid source 31 and deionized water from a deionized water source 33. Thus, dilute sulfuric acid is formed by diluting concentrated sulfuric acid with deionized water. The sulfuric acid source 31 and mixing tank 29 are in communication through piping 35 with a control valve 37 mounted thereon for controlling the flow rate. The deionized water source 33 and the mixing tank 29 are in communication through piping 41 with a control valve 43 mounted thereon for controlling the flow rate. The dilute sulfuric acid formed here is supplied to the treating tank 1 through a feed port 45 provided in a lower part of the mixing tank 29. The feed port 45 is connected to a nozzle 47 disposed above the collecting tub 3 through piping 49 with a pump 51 mounted thereon. A control valve 53 is disposed downstream of the pump 51.

The preliminary mixing unit 27 includes a concentration meter 55 for detecting concentration of the dilute sulfuric acid from time to time, and outputting it as a measured concentration value PC. The measured concentration value PC from the concentration meter 55 is applied to a controller 57. The controller 57 controls the control valves 37 and 41 to bring the sulfuric acid concentration to a predetermined value, and mix the sulfuric acid and deionized water beforehand, thereby forming the dilute sulfuric acid. Subsequently, the controller 57 compares the measured concentration value PC with a predetermined concentration value, and supplements an appropriate quantity according to a difference. Specifically, when the sulfuric acid concentration in the dilute sulfuric acid is low, the control valve 37 is operated to supplement the sulfuric acid. When the sulfuric acid concentration in the dilute sulfuric acid is high, the control valve 43 is operated to supplement the deionized water. When supplying the dilute sulfuric acid from the preliminary mixing unit 27 to the treating tank 1, the controller 57 controls delivery from the pump 51, and switching and opening of the control valve 53.

Besides the controls noted above, the controller 57 controls delivery from the pump 11, heating temperature of the heater 13, vertical movement of the holding arm 17, and so on.

The nozzle 19 corresponds to the treating solution supply device and the second supply piping in this invention. The piping 35 corresponds to the sulfuric acid supply device in this invention. The piping 41 corresponds to the deionized water supply device in this invention. The nozzle 47 corresponds to the treating solution supply device and the first supply piping in this invention. The concentration meter 55 corresponds to the concentration measuring device in this invention. The controller 57 corresponds to the concentration control device in this invention.

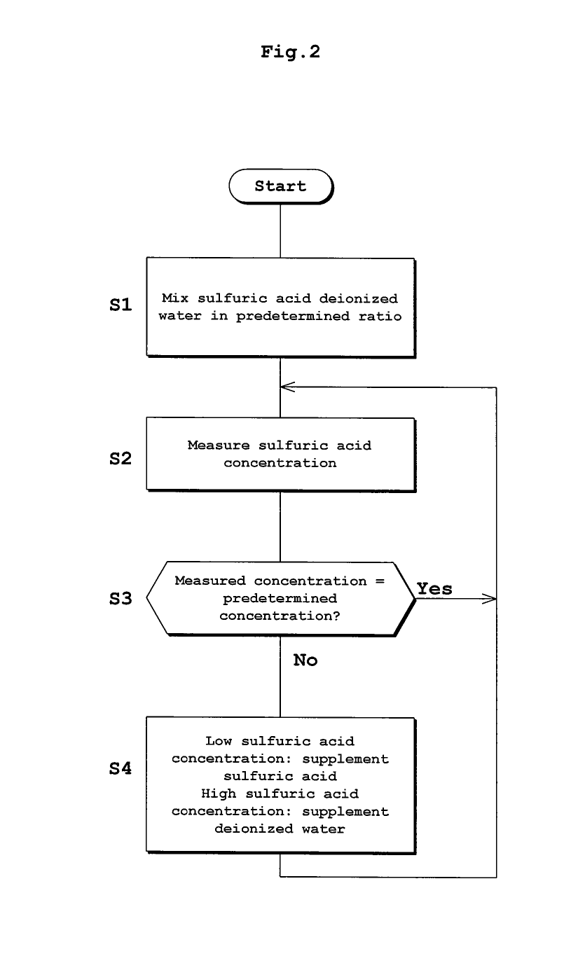

Next, a preliminary operation of the above apparatus will be described with reference to FIG. 2. FIG. 2 is a flow chart showing a preparing process. This process is carried out before actual treatment of wafers W.

Step S1

To attain a predetermined concentration in percent by weight beforehand, the controller 57 controls the control valves 37 and 43 to supply the sulfuric acid and deionized water to the mixing tank 29. The sulfuric acid is what is called concentrated sulfuric acid having a 96% sulfuric acid concentration, for example. The predetermined concentration value is, for example, about 80% by weight of sulfuric acid in the dilute sulfuric acid.

Steps S2-S4

The controller 57 receives a measured concentration value PC from the concentration meter 55 (step S2), compares this measured concentration value PC with the predetermined concentration value (Step S3), and supplement the sulfuric acid or deionized water according to a difference found (step S4). These steps S2-S4 are executed also during the treatment described hereinafter, to avoid variations in the concentration of the dilute sulfuric acid. By maintaining the concentration of the dilute sulfuric acid at a fixed level, the treating solution prepared as described hereinafter is given a constant treating capability, thereby stabilizing the treatment over a long period of time.

The above process corresponds to the first preparing step in this invention. The above sulfuric acid concentration, for the reason discussed hereinafter, may be determined as desired, as long as it is in a range of 70 to 90% by weight, by taking a treating time, cleanliness and so on into account.

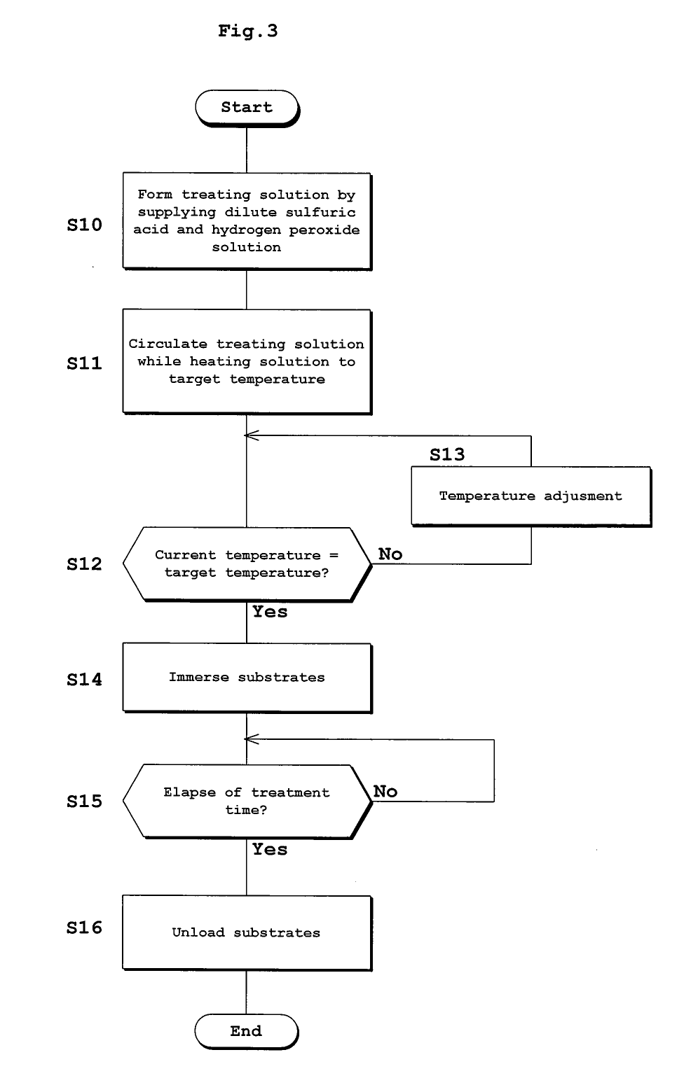

Next, the main operation of the apparatus following the preparation of the dilute sulfuric acid will be described with reference to FIG. 3. FIG. 3 is a flow chart showing a treating process.

Step S10 (Second Preparing Step)

The controller 57 controls the pump 51 and control valve 53 to supply a predetermined quantity of dilute sulfuric acid through the piping 49 and from the nozzle 47 to the treating tank 1. The controller 57 controls also the control valve 25 to supply a predetermined quantity of hydrogen peroxide solution from the nozzle 19 to the treating tank 1. As a result, a treating solution corresponding to the conventional SPM solution is prepared. Since the dilute sulfuric acid and hydrogen peroxide solution are mixed to form the treating solution in the treating tank 1, the wafers W can be treated with the treating solution having a high treating capability.

Step S11

The controller 57 operates the pump 11 to circulate the treating solution through the piping 9, and operates the heater 13 to heat the solution to a target temperature. The target temperature is 160° C., for example.

Steps S12 and S13

The controller 57 receives a current temperature from a thermometer not shown, and controls the heater 13 to make a temperature adjustment according to a difference from the target temperature.

Steps S14 and S15

When the target temperature is reached, the controller 57 lowers the holding arm 17 from the standby position to the treating position (the position shown in FIG. 1) to immerse the wafers W in the treating solution (for the treating step). This state is maintained for a predetermined time to perform treatment of the wafers W. This treatment consists in stripping of photoresist film from the wafers W, for example.

Step S16

Upon lapse of the predetermined time, the controller 57 raises the holding arm 17 to the standby position. Then, the controller 57 moves the holding arm 17 to a cleaning tank not shown, for cleaning treatment with deionized water.

As described above, dilute sulfuric acid is prepared beforehand by mixing the sulfuric acid from the piping 35 and the deionized water from the piping 41. The treating solution is prepared by supplying the hydrogen peroxide solution and the dilute sulfuric acid from the mixing tank 29 via nozzle 19 and nozzle 47 to the treating tank 29. The wafers W are immersed in the treating solution for treatment. Since the treating solution is prepared by mixing the hydrogen peroxide solution and the dilute sulfuric acid prepared beforehand in the mixing tank 29, a rapid reaction of the treating solution is inhibited to avoid a temperature increase of the treating solution due to the reaction. This facilitates a temperature control to attain a treating temperature, and facilitates handling of the treating solution. Since the treating solution is never heated to temperatures higher than is expected, there is no possibility of adversely influencing the components such as the treating tank 1.

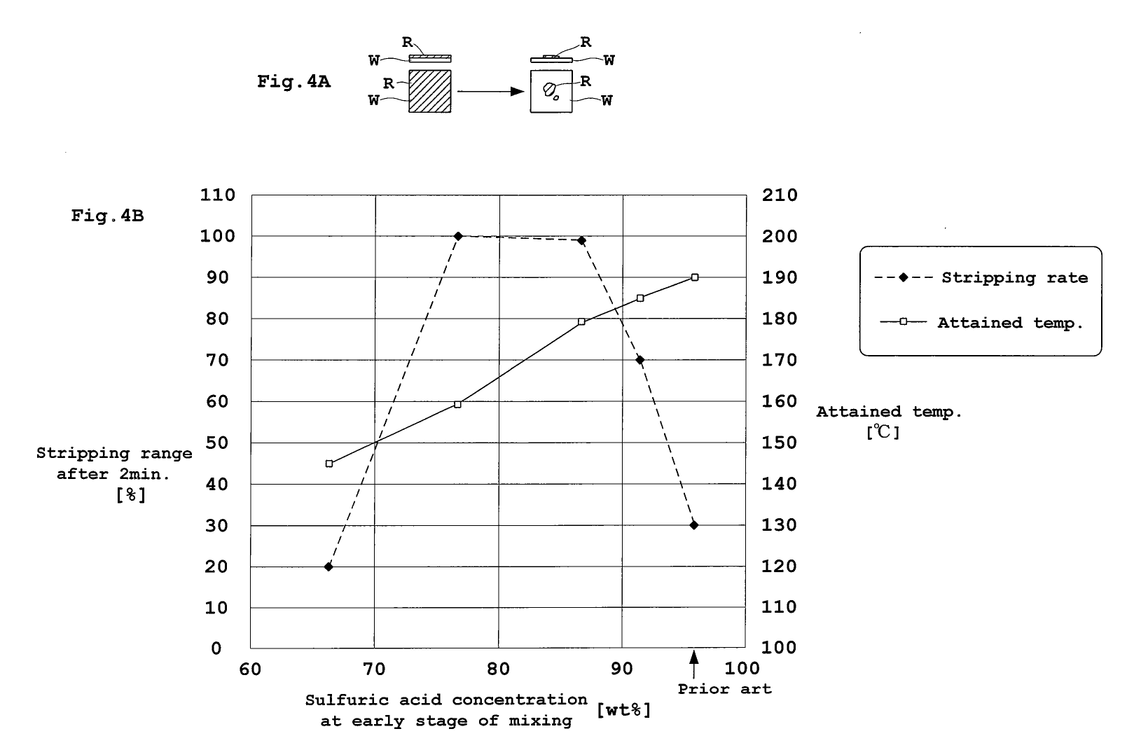

Next, a preferred concentration of the dilute sulfuric acid prepared beforehand will be described with reference to FIGS. 4A and 4B. FIG. 4A is a schematic view of a sample. FIG. 4B shows a graph comparing the stripping capabilities of this invention and the prior art.

As shown in FIG. 4A, Inventor herein coated wafers W of 2 cm square with photoresist film R, immersed the wafers W in treating solutions of varied concentrations for 2 minutes, and measured stripping speeds based on areas of the photoresist film R stripped off. Further, Inventor caused dilute sulfuric acid and the hydrogen peroxide solution to react and increase in temperature, and measured a maximum temperature finally attained. The results are shown in the graph of FIG. 4B. The 96% by weight at the right-hand end represents the prior art. The concentrations on the horizontal axis are sulfuric acid concentrations at an early stage of mixing, and indicate the concentrations of sulfuric acid in the dilute sulfuric acid.

The results show that concentrations less than 70% by weight are not realistic since treating speed is too slow and the treatment will take a long time although low temperatures are attained due to temperature increase. On the other hand, concentrations exceeding 90% by weight result in temperatures attained due to temperature increase nearly as high as in the prior art, and in slow treating speeds requiring a long treating time. Thus, a preferred concentration is in the range of 70 to 90% by weight, which attains a lower temperature than in the prior art, and secures a higher treating speed than the prior art.

### Embodiment 2

Next, Embodiment 2 of this invention will be described.

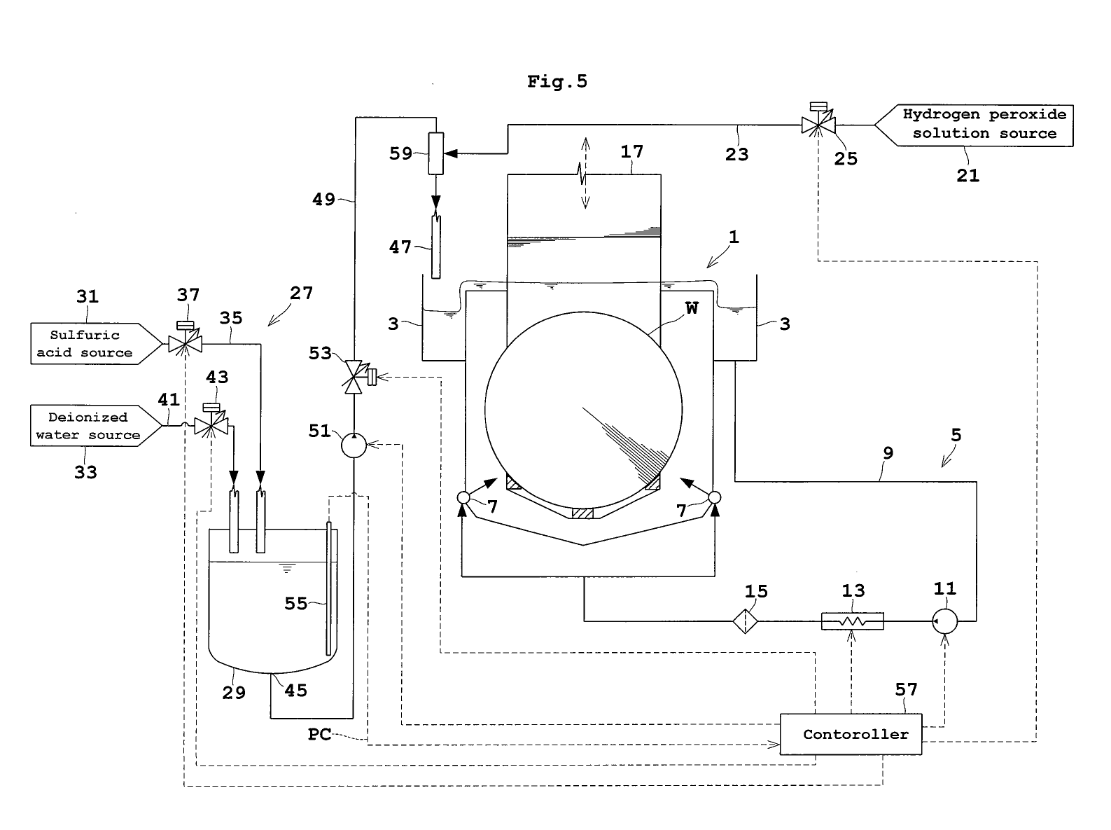

FIG. 5 is a block diagram showing an outline of a substrate treating apparatus in Embodiment 2. Like reference numerals are used to identify like parts, which are the same as in Embodiment 1 and will not particularly be described again.

In Embodiment 1 described hereinbefore, the treating solution is prepared by supplying the dilute sulfuric acid and hydrogen peroxide solution from the nozzle 47 and nozzle 19 directly to the treating tank 1. This embodiment is different in that the dilute sulfuric acid and hydrogen peroxide solution are mixed before being supplied to the treating tank 1.

That is, a mixing valve 59 is mounted on the piping 49 upstream of the nozzle 47. The mixing valve 59 is in communication with the piping 23 connected to the hydrogen peroxide solution source 21. Thus, in the mixing valve 59, the dilute sulfuric acid and hydrogen peroxide solution are mixed, and the mixture is supplied as the treating solution to the nozzle 47 located downstream.

This construction provides functions and effects similar to those of Embodiment 1, and simplifies the upper part of the treating tank 1.

This invention is not limited to the foregoing embodiments, but may be modified as follows:

(1) In each embodiment described above, the substrates under treatment are shaped substantially circular. The invention is applicable also to square substrates and glass substrates.

(2) In each embodiment described above, the preliminary mixing unit 27 adjusts the concentration of dilute sulfuric acid in the mixing tank 29 according to a measured concentration value outputted from the concentration meter 55. The concentration meter 55 is not required where there is no variation in concentration or there are only very slight variations not influencing the preparation of the treatment solution.

(3) Each embodiment described above can supply only the SPM solution as the treating solution. The construction may be modified to supply also deionized water to the piping 9, for allowing deionized water cleaning to be conducted continuously following the treatment with the treating solution. This realizes efficient treatment without the necessity of moving the wafers W.

This invention may be embodied in other specific forms without departing from the spirit or essential attributes thereof and, accordingly, reference should be made to the appended claims, rather than to the foregoing specification, as indicating the scope of the invention.

What is claimed is:

1. A substrate treating method for treating substrates with a treating solution including sulfuric acid and a hydrogen peroxide solution, comprising:
a first preparing step for preparing dilute sulfuric acid of a predetermined concentration by mixing deionized water and sulfuric acid;
a second preparing step for preparing the treating solution by mixing the dilute sulfuric acid prepared in said first preparing step and the hydrogen peroxide solution; and
a treating step for treating the substrates, in a treating unit that receives the substrates, with the treating solution prepared in said second preparing step.

2. A method as defined in claim 1, wherein said first preparing step is executed to maintain a fixed sulfuric acid concentration in the dilute sulfuric acid, after the dilute sulfuric acid of the predetermined concentration is prepared, by adding one of the deionized water and the sulfuric acid according to concentration variations of the dilute sulfuric acid.

3. A method as defined in claim 1, wherein said second preparing step is executed to supply the dilute sulfuric acid and the hydrogen peroxide solution directly to said treating unit.

4. A method as defined in claim 2, wherein said second preparing step is executed to supply the dilute sulfuric acid and the hydrogen peroxide solution directly to said treating unit.

5. A method as defined in claim 1, wherein the concentration of said dilute sulfuric acid is 70 to 90% by weight.

6. A method as defined in claim 2, wherein the concentration of said dilute sulfuric acid is 70 to 90% by weight.

7. A method as defined in claim 3, wherein the concentration of said dilute sulfuric acid is 70 to 90% by weight.

8. A method as defined in claim 4, wherein the concentration of said dilute sulfuric acid is 70 to 90% by weight.

9. A substrate treating apparatus for treating substrates with a treating solution including sulfuric acid and a hydrogen peroxide solution, comprising:
a mixing unit for mixing deionized water and sulfuric acid to prepare dilute sulfuric acid of a predetermined concentration;
a sulfuric acid supply device for supplying the sulfuric acid to said mixing unit;
a deionized water supply device for supplying the deionized water to said mixing unit;
a treating unit for receiving the substrates and treating the substrates with the treating solution; and
a treating solution supply device for supplying said treating unit with the hydrogen peroxide solution and the dilute sulfuric acid from said mixing unit as the treating solution.

10. An apparatus as defined in claim 9, wherein said mixing unit includes a mixing tank for storing the dilute sulfuric acid prepared to have the predetermined concentration, a concentration measuring device for measuring a sulfuric acid concentration in the dilute sulfuric acid, and a concentration control device for maintaining a fixed sulfuric acid concentration in the dilute sulfuric acid by causing one of said sulfuric acid supply device to supply the sulfuric acid, and said deionized water supply device to supply the deionized water, to said mixing unit, according to a result of measurement by said concentration measuring device.

11. An apparatus as defined in claim 10, wherein said treating unit includes:
a treating tank for storing the treating solution in which the substrates are immersed;
a first supply piping for supplying the dilute sulfuric acid from said mixing tank to said treating tank; and
a second supply piping for supplying the hydrogen peroxide solution to said treating tank;
whereby the treating solution is prepared in said treating tank.

12. An apparatus as defined in claim 10, wherein said treating unit includes:
a treating tank for storing the treating solution in which the substrates are immersed;
a first supply piping for supplying the dilute sulfuric acid from said mixing tank to said treating tank;
a mixing valve mounted on said first supply piping, in a position adjacent said treating tank; and
a second supply piping for supplying the hydrogen peroxide solution to said treating tank;
whereby the treating solution is prepared in said mixing valve.

13. An apparatus as defined in claim 11, wherein said treating tank has a collecting tank for collecting overflows of the treating solution, a bottom of said treating tank and a bottom of said collecting tank being interconnected through piping.

14. An apparatus as defined in claim 12, wherein said treating tank has a collecting tank for collecting overflows of the treating solution, a bottom of said treating tank and a bottom of said collecting tank being interconnected through piping.

15. An apparatus as defined in claim 13, wherein said piping has an in-line heater for heating the treating solution circulating therethrough.

16. An apparatus as defined in claim 14, wherein said piping has an in-line heater for heating the treating solution circulating therethrough.

17. An apparatus as defined in claim 9, wherein the concentration of said dilute sulfuric acid is 70 to 90% by weight.

18. An apparatus as defined in claim 10, wherein the concentration of said dilute sulfuric acid is 70 to 90% by weight.

19. An apparatus as defined in claim 11, wherein the concentration of said dilute sulfuric acid is 70 to 90% by weight.
